(19) United States
(12) Patent Application Publication
(10) Pub. No.: US 2013/0126681 A1
(43) Pub. Date: May 23, 2013

(54) Threaded brackets for hanger rod

(71) Applicant: ELLIOTT GREENFIELD, ELKINS PARK, PA (US)

(72) Inventor: ELLIOTT GREENFIELD, ELKINS PARK, PA (US)

(73) Assignee: GREENFIELD MFG CO INC, PHILADELPHIA, PA (US)

(21) Appl. No.: 13/303,101

(22) Filed: Nov. 22, 2011

(51) Int. Cl. F16L 3/08; B21J 15/02

(52) U.S. Cl. 248/62; 248/58; 29/525.06

(57) ABSTRACT

A mounting member for a ceiling or beam utilizes a barrel nut for connection with a hanger rod of a pipe hanging support. A technique of creating a riveted joint with a keyed hole to join the barrel nut and then deforming that portion of the rivet into the key way to provide secure fixation of the nut in the member to prevent rotation of the nut when the hanger rod is turned.

### BACKGROUND OF THE INVENTION

The present invention relates to devices for hanging pipes below ceilings and beams, and, in particular, to a mounting plate or bracket incorporating threads for receiving a hanger rod used to suspend piping.

There is a multitude of pipe hanger products utilized by piping contractors in the commercial and industrial piping fields. Generally, these products allow various size pipes to be suspended from ceilings or beams within a facility, as the circuits formed by the piping are routed through a building. These products include clamps, hooks, straps, plates, and brackets, among other items. Hanger rods, for example, are used in suspending a pipe where the upper end of the rod is attached to a bracket mounted to a beam and the lower end of the rod is attached to a ring hanger supporting the pipe. The hanger rod is threaded, and a hole in the bracket is tapped to receive the rod. The initiation of the threaded connection between the rod and bracket hole is often awkward, however, due to the relatively precise alignment of the threads that is required.

Further, in the example above, the threaded connection of the hanger rod to the bracket is limited to the thickness of the bracket. Increased threaded contact is possible by either a larger diameter hole or a thicker bracket. An increase in hole diameter affects the load capability of the bracket, unless the bracket is made proportionately wider. However, for either a thicker or wider bracket, there is an increase in the bracket weight and therefore an increase in the load supported by the beam.

A typical technique for manufacturing plates and brackets for mounting to ceilings and beams includes a first production line for the fabrication of the plate or bracket with screw or bolt holes and then a second production line for tapping holes for the hanger rods. These products are often made of cast iron also. This separation of procedures increases both the time and cost of manufacturing the plates and brackets.

### SUMMARY OF THE INVENTION

A mounting bracket constructed in accordance with the present invention for hanging a pipe support overcomes the previously noted disadvantages by incorporating a ring nut or barrel nut which allows an increased threaded connection with a hanger rod and also makes the initiation of the connection with the rod easier. By shaping the plates to accommodate the nut a more rigid structure is obtained using less steel.

A mounting member of the present invention comprises a plate or bracket or clamp mounting element having at least one mounting hole or clamp hole and another hole to receive a barrel nut. The barrel nut has a reduced area at one end and a threaded interior for receiving a hanger rod or the like. The nut is secured in the hole of the mounting element such that the flange contacts an upper surface of the element and the reduced area extends below the element.

After the insertion of the barrel nut into the hole, a die or tool is used to rivet the reduced area over the lower surface. This tool also presses part of the riveted surface into one or more keyed notches, which were precut around the hole into the plate. This greatly increases the amount of torque, which can be applied to the nut. This method lends itself to automated assembly, as the nut requires no rotary orientation into the hole. The nut is not required to deform the hole so may be soft not hardened. The keyed hole as well as the keyed staking tool is all aligned within the progressive manufacturing tool. The barrel nut is automatically inserted within this tool as well.

A method of the present invention for manufacturing a mounting member constructed in accordance with the present invention comprises the steps of:

a) Fabricating a strip of metal having a length equal to the length of an element of the mounting member;
b) Forming a keyed hole in the metal strip;
c) Vertically positioning a barrel nut through the keyed without rotary orientation.
d) Riveting the area around the nut and staking the flared area into the keyway so that the metal of the rivet is pressed into the keyed area preventing rotation of the nut.

For a side bracket embodiment of the mounting member, the method of the present invention preferably comprises riveting and staking after insertion and fixation of the barrel nut. Also, in this embodiment, the method of the present invention further comprises the step of bending the mounting member to form the bracket with two portions at substantially a 90-degree angle to one another.

For a ceiling plate embodiment of the mounting member, the method of the present invention preferably comprises forming the bracket with a curved channel which is raised to allow the flanged portion of the barrel nut to be substantially flush with the mounting surface of the plate.

For the C clamp embodiment of the mounting member, the method of the present invention preferably comprises punching and forming the c clamp then inserting two barrel nuts into said clamp there after staking and riveting the barrel nuts in place and inserting a threaded screw with or without a lock nut to engage a metal beam.

Progressive dies may be used for producing the keyed holes, the offset portions, and the like for each member. The barrel nuts can be mechanically fed into the keyed holes. Further, the method also preferably comprises the step of separating several mounting members from a single metal strip. Thus, the manufacture of a mounting member constructed in accordance with the present invention does not require a separate production line or equipment for tapping of the hole, and the cost is less to use inexpensive, barrel nuts instead.

Further advantages and applications will become apparent to those skilled in the art from the following detailed description and the drawings referenced herein.

### BRIEF DESCRIPTION OF THE DRAWINGS

FIG. 1 is a perspective view of one embodiment of the present invention, wherein a bracket is coupled via a hanger rod to an adjustable clevis hanger to suspend a pipe;

FIG. 2 is a perspective view of the ceiling bracket assembly of FIG. 1;

FIG. 3 is a perspective view of the ceiling bracket assembly of FIG. 1; Showing the keyed hole before insertion of the barrel nut.

FIG. 4 is cross sectional view of the ceiling plate assembly showing the tabs bent into the keyway of the ceiling plate

FIG. 5 is cross sectional view of the ceiling plate assembly showing the barrel nut being riveted around the hole where the tabs do not exist.

FIG. 6 is a perspective view of the combination riveting and tab staking tool.

FIG. 7 is a perspective view of an angle bracket using the same barrel nut and keyway.

FIG. 8 is a perspective view of a c clamp using 2 barrel nuts and a nut locking set screw.

FIG. 9 is a semi section view of the c clamp showing it mounted on a beam with the hanger rod going through the barrel nut.

### DETAILED DESCRIPTION OF THE PREFERRED EMBODIMENTS

### Ceiling Plate Bracket Embodiment

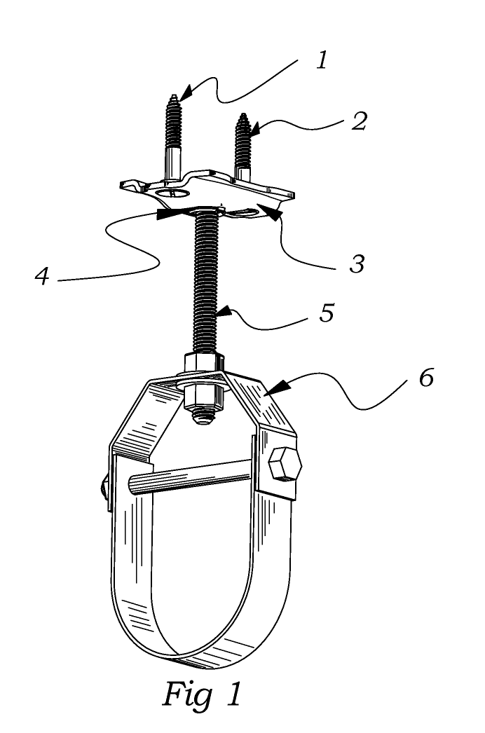

FIG. 1 illustrates a first preferred embodiment of a mounting member in the form of a bracket 3 constructed in accordance with the present invention. As shown, the bracket 3 is used to mount a pipe hanging support rod 5 to the underside of a wood beam using screws 1 and 2. Rod 5 is threaded into barrel nut 4 being attached to plate 3 in accordance with the present invention. Clevis hanger 6 is then attached to the rod to complete the pipe support assembly.

Generally, this type of bracket 3 may be mounted to the beam with wood screws (not shown) or lag bolts, depending upon the size of the piping to be suspended. Wood screws, for example, may be used with the bracket 3 for ½- to 2-inch pipes, while the lag bolt is used for up to 4-inch piping. The rod is typically ⅜ inch in diameter to support ½- to 4-inch pipes.

Although the clevis hanger strap 6 is shown in the form of a ring or tear drop-shaped loop, other types of hangers, such as J-hanger, Loop hanger or others known to those skilled in the art, may be used with the hanger rod 16 to support the pipe. Alternately, eye rods, bolts, or the like may be used with the bracket 3 to suspend various types of pipe supports. And, as the piping size varies, so too do the appropriate sizes for the hanger and rod support elements.

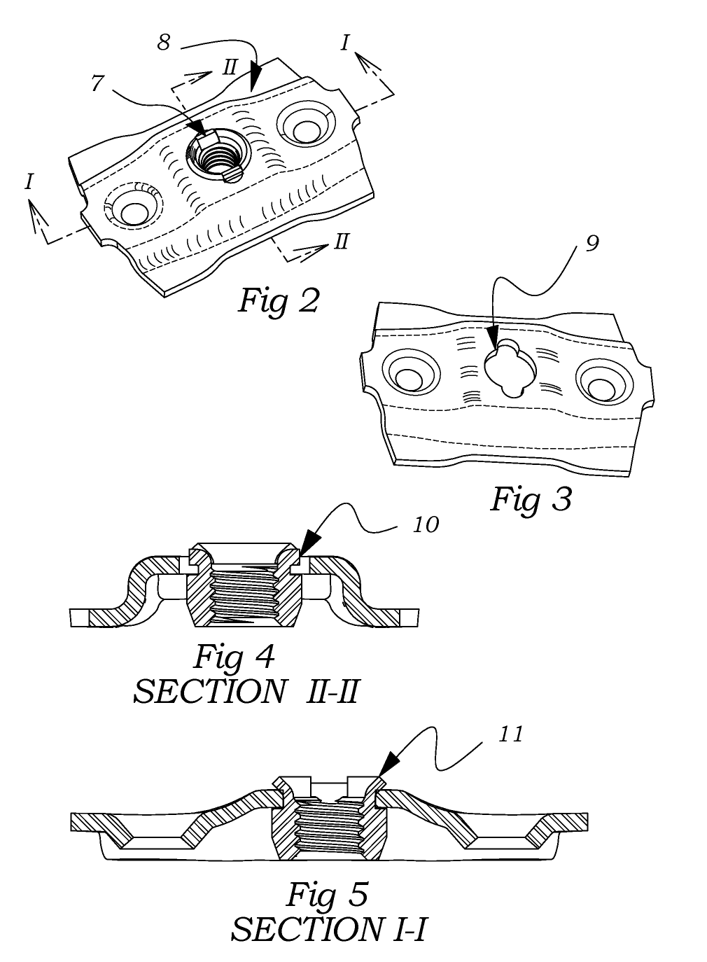

FIG. 2 shows the barrel nut riveted and stacked into the part forming a complete assembly. Looking at FIG. 3 one can see the keyed hole 9 used for its retention. The keyway 9, is aligned with the staking tool, forming a locking device which then prevents rotation of the barrel nut to facilitate assembly with the rod.

FIG. 4 shows a cutaway section aligned with the keyways through the center of the part. Note 10 points to the bent down portion of the barrel nut being staked into the keyed portion of the hole. FIG. 5 shows that part of the hole that is not part of the keyway. Here one can see the riveting of the barrel nut. This retains the barrel nut in place to prevent it from being pushed out by the rod. The sizeable flange on the other side of the plate typically supports the load.

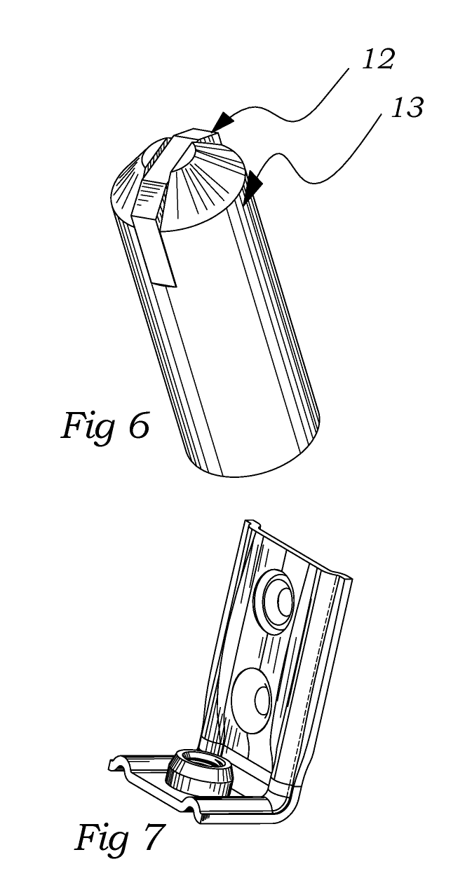

FIG. 6 shows the preferred embodiment of the combination tool used to both stake the barrel nut into the keyways and simultaneously riveting our the barrel nut reduced area to form a flange around the adjoining member. The tool may be made of two pieces held together to facilitate its construction.

### Side Beam Bracket Embodiment

Referring now in detail to FIG. 7, the bracket preferably comprises an element forming an L-shape, where lateral cross-sections taken along its length are rectangular. The bracket shown uses the same keyed locking element of this invention to hold the barrel nut and is offset to allow for dimpled countersinks for use with flat head screws. The offset is only one version of the bracket as these may be eliminated and a flush to the wall version is also used. Here again the keyway stops rotation of the barrel nut allowing for easy assembly with a suitable threaded hanger rod.

### C Clamp Bracket Embodiment

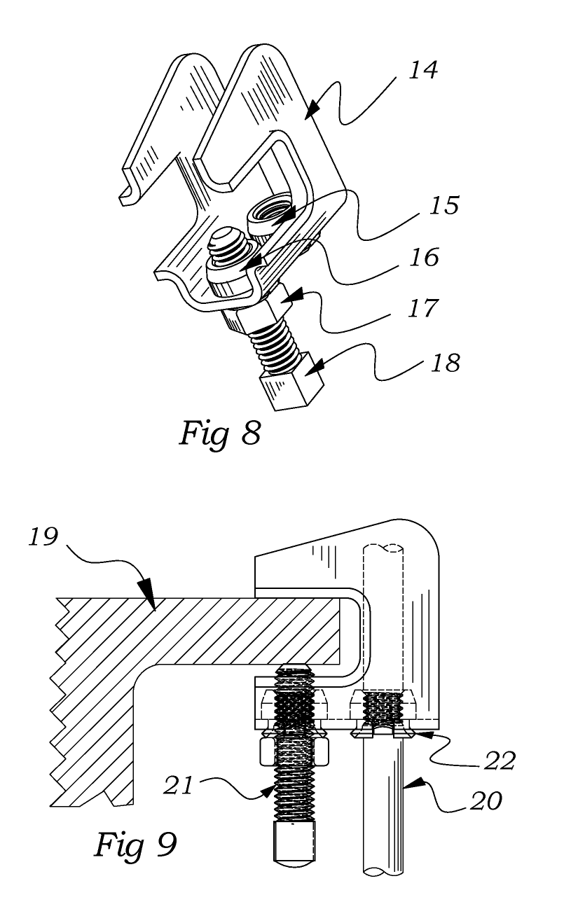

FIG. 8 is a C clamp, the design of which is illustrated in Heath (U.S. Pat. No. 4,570,885). In his patent Heath shows the C clamp with metal sufficiently thick enough to support the threads required for the set screw and rod. By inserting barrel nuts into a similar shaped hanger thinner material may be used reducing the overall cost of the product. As seen in FIG. 8, the C form detail, 14, has in its base, two barrel nuts, detail 15 and 16. These barrel nuts are riveted and staked according to the specifications of this invention. Barrel nut detail 16 receives a set screw, of any type and may also have a lock nut, which is optional and is used to fasten the clamp to a metal construction beam. Barrel nut, detail 15, receives the hanger rod used to support the pipe.

FIG. 9 shows a side view of the applied C clamp. Here one may clearly see the clamp applied to beam 19 using set screw 21 to affix it. Rod 20 is then inserted into barrel nut 22 to support various pipe hangers.

The embodiments illustrated and described above are provided merely to illustrate possible incarnations of the present invention. Other changes and modifications can be made from the embodiments presented herein by those skilled in the art without departure from the spirit and scope of the invention, as defined by the appended claims.

What is claimed is:

1. A pipe support assembly for suspending a pipe, comprising:
a pipe hanger rod; means for receiving and supporting the pipe when attached to a lower end of said rod; a bracket for attachment to a raised support; and a barrel nut having a cylindrical portion extending through a keyed hole which may have multiple key ways in the bracket, with a flange on one end of the nut engaging an area of the bracket surrounding the hole, said nut having internal threads, threadably receiving an upper threaded end of said rod, the end of said nut being riveted into said hole and being deformed into the key ways of said hole to grip the nut and prevent movement of the nut relative to the bracket when the rod is inserted into an opposite end of the nut and rotated into threaded engagement with the internal threads.

2. A pipe support assembly for suspending a pipe, comprising:
a C shaped clamp with two barrel nuts having a cylindrical portion extending through keyed holes which may have multiple key ways in the bracket, with a reduced diameter on one end of the nut engaging an area of the bracket surrounding the hole, said nut having internal threads and one of these nuts threadably receiving a screw to clamp the c shape to a beam and the other nut to receive a threaded rod or fastener to support a pipe hanger having each of these nuts being riveted into said hole and being deformed into the key ways of said hole to grip the nut and prevent movement and rotation of the nut relative to the bracket when the rod or fastener is inserted into an opposite end of the nut and rotated into threaded engagement with the internal threads.

3. A method of supporting the upper end of a threaded support rod, comprising the steps of:
forming a keyed hole in a horizontal portion of a bracket;
inserting a cylindrical portion of a barrel nut into the bracket hole with a reduced diameter on one end of the barrel nut engaging a portion of the bracket surrounding the hole;
riveting said portion of the bracket surrounding the hole in a manner which deforms the reduced diameter to enlarge it around the hole and staking said reduced diameter into the key way or key ways so as to prevent rotation of the barrel nut within the bracket hole;
inserting a threaded end of the support rod or bolt into a lower end of the barrel nut and rotating the rod into internal threads within the barrel nut.

4. A method as in claim 3 where the bracket used is a shaped plate designed to mount on a flat surface and allow space behind for the barrel nut.

5. A method as in claim 3 where the bracket is bent at right angles to the barrel nut and allows for one or more holes to support the bracket against a beam with appropriate fasteners.

6. A method as in claim 3 where the bracket is in the form of a c shaped clamp where in two barrel nuts are used one being used to clamp the bracket to a structural beam.
